(19) United States
(12) Patent Application Publication
(10) Pub. No.: US 2026/0112842 A1
(43) Pub. Date: Apr. 23, 2026

(54) CONNECTOR ASSEMBLY

(71) Applicant: Bellwether Electronic Corp., Taoyuan City (TW)

(72) Inventors: Jimmy Enrique ACERA, Taoyuan City (TW); Chih-Ming TSAI, Taoyuan City (TW)

(21) Appl. No.: 19/348,750

(22) Filed: Oct. 2, 2025

Related U.S. Application Data
(60) Provisional application No. 63/708,767, filed on Oct. 18, 2024.

(51) Int. Cl. H01R 13/627

(52) U.S. Cl. CPC H01R 13/627

(57) ABSTRACT

A connector assembly includes a first connector and a second connector. The first connector includes a first insulating housing, some first terminals and a snapping element. The first terminals connect with the first insulating housing. The snapping element is elastically connected with the first insulating housing along a first direction. The second connector includes a second insulating housing, some second terminals and a snapping portion. The second insulating housing at least partially abuts against the first insulating housing. The second terminals connect with the second insulating housing. The second terminals connect with the first terminals along a second direction intersecting with the first direction. The snapping portion is connected with the second insulating housing and at least partially inserted into the first insulating housing. The snapping element moves along the first direction relative to the first insulating housing to snap with the snapping portion.

### RELATED APPLICATIONS

This application claims priority to U.S. Provisional Application Ser. No. 63/708,767, filed Oct. 18, 2024, which is herein incorporated by reference in its entirety.

### BACKGROUND

### Technical Field

The present disclosure relates to connector assemblies.

### Description of Related Art

As the pace of modern life continues to accelerate, the demand for electronic devices has been steadily increasing. Facing to a huge consumer market, manufacturers are not only focused on enhancing the functionality and performance of their products but also striving hard to improve the reliability and stability of electronic devices in order to boost the market competitiveness of their brands.

Taking power connectors as an example, the measure to effectively reduce their size to save space while ensuring more reliable connections between electronic devices at a low cost is undoubtedly an important issue that the industry high concerns about.

### SUMMARY

A technical aspect of the present disclosure is to provide a connector assembly, which can achieve a secured and reliable connection, and effectively reduce the overall space occupied.

According to an embodiment of the present disclosure, a connector assembly includes a first connector and a second connector. The first connector includes a first insulating housing, a plurality of first terminals and a snapping element. The first terminals are connected with the first insulating housing. The snapping element is elastically connected with the first insulating housing along a first direction. The second connector includes a second insulating housing, a plurality of second terminals and a snapping portion. The second insulating housing is configured to at least partially abut against the first insulating housing. The second terminals are connected with the second insulating housing. The second terminals are configured to be connected with the first terminals along a second direction. The second direction is intersected with the first direction. The snapping portion is connected with the second insulating housing. The snapping portion is configured to be at least partially inserted into the first insulating housing. The snapping element is configured to move along the first direction relative to the first insulating housing to snap with the snapping portion.

In one or more embodiments of the present disclosure, the snapping portion has a first through hole. The snapping element includes a first main body and a hooking portion. The first main body has a first surface, a second surface and a third surface. The first surface and the second surface are opposite to each other. The third surface is connected between the first surface and the second surface. The first surface has an inner edge. The inner edge surrounds to define a recessed space. The hooking portion is disposed on the second surface. The hooking portion is configured to at least partially penetrate through the first through hole. The first connector further includes an elastic element and a moving element. The elastic element is connected between the third surface and the first insulating housing along the first direction. The moving element includes a second main body and a protruding portion. The second main body is at least partially located inside the first insulating housing. The second main body is configured to move along the second direction. The protruding portion is connected with the second main body. The protruding portion has an abutting surface. The abutting surface is at least partially inclined relative to the first direction. The abutting surface is configured to abut against the inner edge in order to push the snapping element to move along the first direction to compress the elastic element, such that the protruding portion is at least partially accommodated in the recessed space.

In one or more embodiments of the present disclosure, the first insulating housing includes two lateral plates. The lateral plates are opposite to each other. The lateral plates respectively have a limiting hole. The limiting hole extends along the second direction. The limiting hole is divided into a first zone, a second zone and a limiting zone communicated with each other. The limiting zone is located between the first zone and the second zone. The limiting hole has a first width at the first zone. The limiting hole has a second width at the second zone. The limiting hole has a third width at the limiting zone. The first width is equal to the second width. The third width is less than the first width and the second width. The moving element further includes two limiting portions. The limiting portions are disposed on two opposite sides of the second main body. The limiting portions are configured to snap with a corresponding one of the limiting holes. Each of the limiting portions has a fourth width. The fourth width is equal to the first width and the second width.

In one or more embodiments of the present disclosure, the first insulating housing further includes a first isolating plate and a second isolating plate. The first isolating plate is connected between the lateral plates. The second isolating plate is connected between the lateral plates. The second isolating plate and the first isolating plate define an activity space therebetween. The moving element is at least partially located in the activity space. The limiting holes are located between the first isolating plate and the second isolating plate. The first isolating plate and the second isolating plate are at least partially located between the first terminals.

In one or more embodiments of the present disclosure, each of the first terminals includes a first contacting portion, a first connecting portion and an elastic sleeve. The first contacting portion has a via hole. The elastic sleeve is located in the via hole. The first connecting portion is connected with the first contacting portion. The first insulating housing includes a top plate, a base plate, a front plate and a rear plate. The lateral plates are connected between the top plate and the base plate. The base plate has a first opening, a second opening and a third opening. The first isolating plate and the second isolating plate are disposed between the base plate and the top plate. The first isolating plate and the second isolating plate are located between the first opening and the second opening. The via holes respectively align with the first opening and the second opening. The third opening is located between the first isolating plate and the second isolating plate. The third opening is configured to be penetrated through by the snapping portion. The front plate is connected with the top plate, the base plate and the lateral plates. The rear plate is connected between the lateral plates. At least one of the first connecting portions passes through the rear plate and is at least partially exposed out of the first insulating housing.

In one or more embodiments of the present disclosure, the first isolating plate has a first height relative to the base plate. The second isolating plate has a second height relative to the base plate. The first height is larger than the second height. The first connecting portion of at least one of the first terminals sequentially passes the first isolating plate, the second isolating plate and the first contacting portion of at least another one of the first terminals. The rear plate is located between the first connecting portions. The first connecting portions are at least partially exposed out of the first insulating housing.

In one or more embodiments of the present disclosure, the first isolating plate has a first height relative to the base plate. The second isolating plate has a second height relative to the base plate. The first height is larger than the second height. The first connecting portion of at least one of the first terminals is located between the front plate and the rear plate and sequentially passes the first isolating plate and the second isolating plate to connect with the first contacting portion of at least another one of the first terminals, such that the first terminals form an integrally formed structure.

In one or more embodiments of the present disclosure, the top plate has two avoidance portions. The avoidance portions are respectively recessed from two opposite edges of the top plate. The second main body includes a structural portion, two pivotal portions and two extending portions. The protruding portion is connected with the structural portion. The extending portions are respectively connected between the structural portion and a corresponding one of the pivotal portions. The limiting portions are disposed at two opposite sides of the structural portion. The extending portions respectively penetrate through the avoidance portions. The moving element further includes a handle. The handle is pivotally connected with the pivotal portions.

In one or more embodiments of the present disclosure, the second insulating housing includes a plate portion, a wall portion and a plurality of supporting portions. The plate portion has a plurality of second through holes. The second through holes respectively have an inner diameter. The wall portion is connected with the plate portion. The wall portion surrounds to define an accommodation space. The wall portion is connected between the plate portion and the supporting portions. The supporting portions are configured to abut against a board. Each of the second terminals includes a second contacting portion, a second connecting portion and a fixing portion. The second contacting portion penetrates through a corresponding one of the second through holes. The second contacting portion is configured to penetrate through a corresponding one of the first opening and the second opening to connect with a corresponding one of the elastic sleeves. The second connecting portion is configured to be electrically connected with the board. The fixing portion is connected between the second contacting portion and the second connecting portion. The fixing portion is located in the accommodation space. The fixing portion has an outer diameter. The outer diameter is larger than the inner diameter.

In one or more embodiments of the present disclosure, the second insulating housing includes at least one first positioning portion. The first positioning portion is disposed on one of the supporting portions. The first positioning portion is configured to be connected with a second positioning portion of the board.

In one or more embodiments of the present disclosure, the plate portion has at least one locking hole. The second connector further includes at least one locking piece. The locking piece is configured to at least partially penetrate through and snap with the locking hole to lock at the board.

In one or more embodiments of the present disclosure, each of the second contacting portions has a terminal height. The terminal heights are different from each other.

In one or more embodiments of the present disclosure, each of the second contacting portions has a terminal height. The terminal heights are equal to each other.

In one or more embodiments of the present disclosure, the second terminals are arranged along a contacting line. The snapping portion is located between the second terminals and offset from the contacting line. The third opening is close to one of the lateral plates.

According to an embodiment of the present disclosure, a connector assembly includes a cable end connector and a board end connector. The cable end connector includes a first insulating housing, a plurality of first terminals, a plurality of cables, a snapping element and a moving element. The first terminals are connected with the first insulating housing. The cables are connected with the first terminals. The snapping element is disposed inside the first insulating housing and is elastically movable relative to the first insulating housing along a first direction. The moving element is movably connected with the first insulating housing along a second direction. The second direction is intersected with the first direction. The moving element is configured to push the snapping element to at least partially move relative to the first insulating housing along the first direction. The board end connector includes a second insulating housing, a plurality of second terminals and a snapping portion. The second insulating housing is configured to at least partially abut against the first insulating housing. The second terminals are connected with the second insulating housing and configured to be connected with the first terminals along the second direction. The second terminals are electrically connected with a printed circuit board. The snapping portion is connected with the second insulating housing and configured to be at least partially inserted into the first insulating housing. The snapping element is configured to move along the first direction relative to the first insulating housing to snap with the snapping portion.

In one or more embodiments of the present disclosure, the moving element is configured to move relative to the first insulating housing to switch between a first position to push the snapping element and a second position to move away from the snapping element.

The above-mentioned embodiments of the present disclosure have at least the following advantages:
(1) Since the hooking portion of the snapping element at least partially penetrates through the first through hole of the snapping portion, the connection between the first connector and the second connector becomes secured and reliable.
(2) In the process of disconnecting the first connector from the second connector, no additional tools are required, which brings convenience to the user.
(3) Since the snapping portion is located between the second terminals, while the corresponding snapping element and the moving element are both located between the first isolating plate and the second isolating plate, the overall space occupied by the connector assembly can be effectively reduced.

### BRIEF DESCRIPTION OF THE DRAWINGS

The disclosure can be more fully understood by reading the following detailed description of the embodiments, with reference made to the accompanying drawings as follows:

FIG. 1 is a schematic view of a connector assembly according to an embodiment of the present disclosure, in which the first connector and the second connector are separated from each other;

FIG. 2 is a sectional view along the sectional line A-A of FIG. 1;

FIG. 3 is a sectional view along the sectional line B-B of FIG. 2;

FIG. 4 is an exploded schematic view of the moving element, the snapping element and the elastic element of FIG. 3;

FIG. 5 is a sectional view along the sectional line C-C of FIG. 2, in which only the first insulating housing is remained;

FIG. 6 is an enlarged schematic view of the second connector of FIG. 1;

FIG. 7 is a top view of the second connector of FIG. 6;

FIG. 8 is a sectional view along the sectional line D-D of FIG. 7;

FIG. 9 is a sectional view along the sectional line E-E of FIG. 7;

FIG. 10 is a schematic bottom view of the second connector of FIG. 6;

FIG. 11 is a schematic view of the connector assembly of FIG. 1, in which the first connector and the second connector are connected to each other;

FIG. 12 is a sectional view along the sectional line F-F of FIG. 11;

FIG. 13 is a sectional view along the sectional line G-G of FIG. 11;

FIG. 14 is a partial side view of the connector assembly of FIG. 11;

FIG. 15 is a partial section view of a connector assembly according to another embodiment of the present disclosure; and

FIG. 16 is a partial section view of a connector assembly according to a further embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

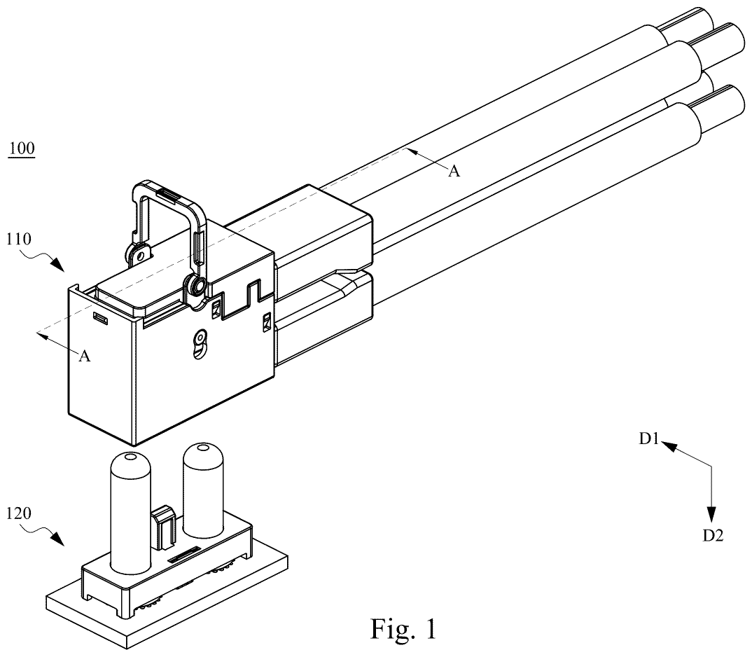

Please refer to FIG. 1. FIG. 1 is a schematic view of a connector assembly 100 according to an embodiment of the present disclosure, in which the first connector 110 and the second connector 120 are separated from each other. In this embodiment, as shown in FIG. 1, a connector assembly 100 includes a first connector 110 and a second connector 120. For example, the first connector 110 is a cable end connector, while the second connector 120 is a board end connector. The first connector 110 is configured to move along a second direction D2 relative to the second connector 120, in order to connect with the second connector 120.

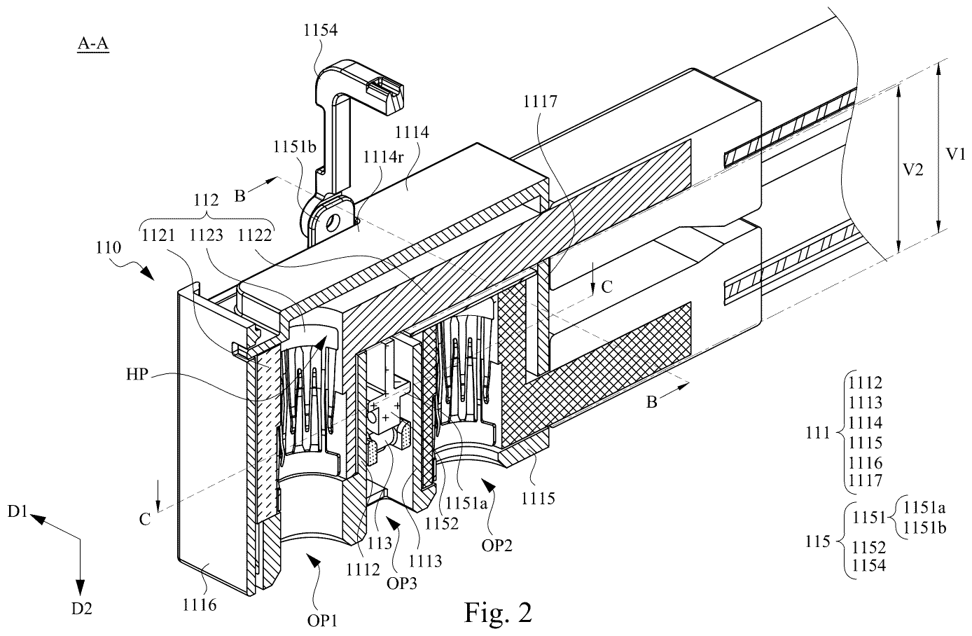

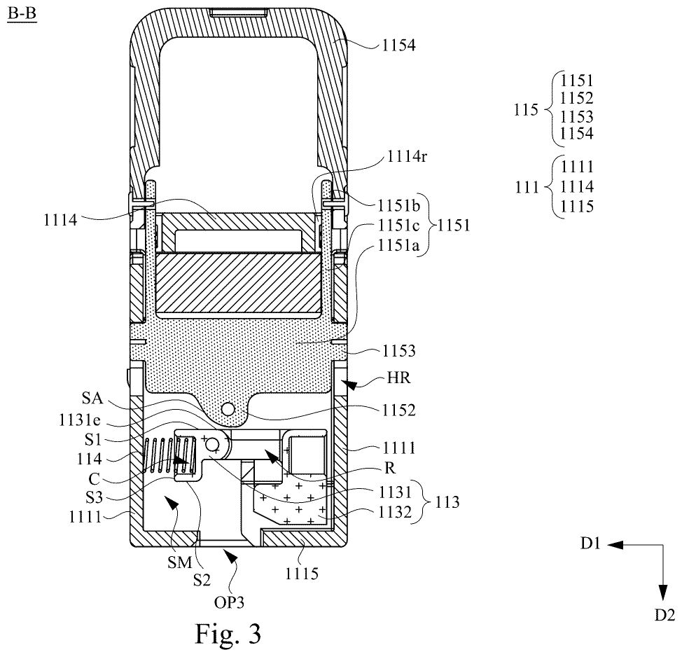

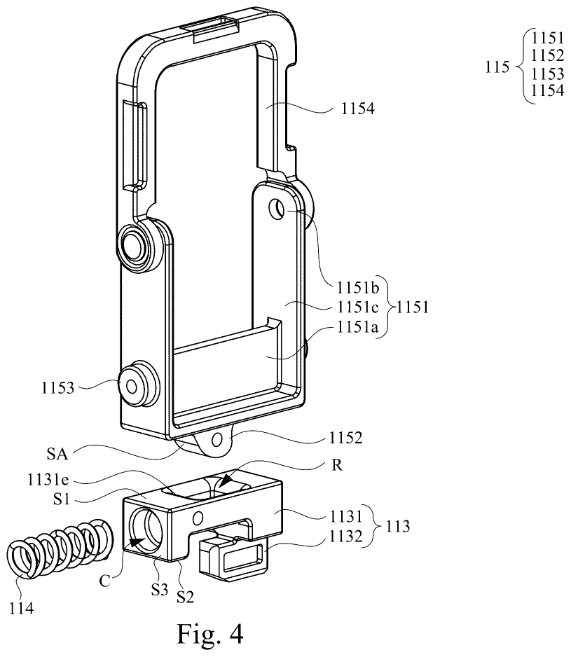

Please refer to FIGS. 2-4. FIG. 2 is a sectional view along the sectional line A-A of FIG. 1. FIG. 3 is a sectional view along the sectional line B-B of FIG. 2. FIG. 4 is an exploded schematic view of the moving element 115, the snapping element 113 and the elastic element 114 of FIG. 3. In this embodiment, as shown in FIGS. 2-4, the first connector 110 includes a first insulating housing 111, a plurality of first terminals 112 and a snapping element 113. The first terminals 112 are connected with the first insulating housing 111. The snapping element 113 is elastically connected with the first insulating housing 111 along a first direction D1. The first direction D1 and the second direction D2 are intersected with each other.

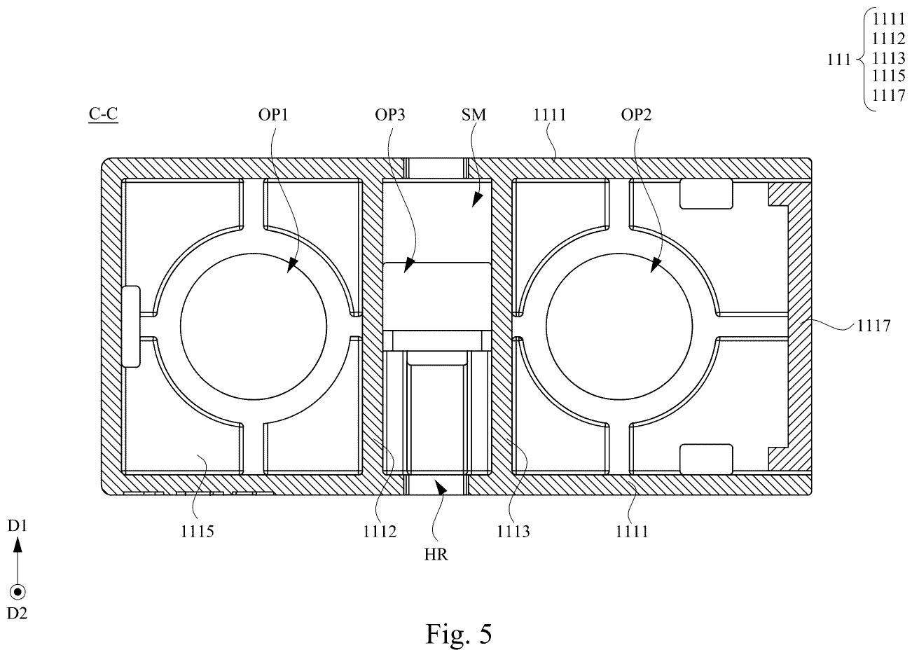

Please refer to FIGS. 2-3 and 5. FIG. 5 is a sectional view along the sectional line C-C of FIG. 2, in which only the first insulating housing 111 is remained. Furthermore, as shown in FIGS. 2-3 and 5, the first insulating housing 111 includes two lateral plates 1111, a top plate 1114, a base plate 1115, a front plate 1116, a rear plate 1117, a first isolating plate 1112 and a second isolating plate 1113. The two lateral plates 1111 are opposite to each other and connected between the top plate 1114 and the base plate 1115. The lateral plates 1111 respectively have a limiting hole HR. The base plate 1115 has a first opening OP1, a second opening OP2 and a third opening OP3. The first isolating plate 1112 and the second isolating plate 1113 are disposed between the base plate 1115 and the top plate 1114, and connected between the two lateral plates 1111. The first isolating plate 1112 and the second isolating plate 1113 are located between the first opening OP1 and the second opening OP2. The second isolating plate 1113 and the first isolating plate 1112 define an activity space SM therebetween. The limiting holes HR are located between the first isolating plate 1112 and the second isolating plate 1113. The third opening OP3 is located between the first isolating plate 1112 and the second isolating plate 1113, meaning the third opening OP3 is communicated with the activity space SM, and the third opening OP3 is close to one of the two lateral plates 1111. The front plate 1116 is connected with the top plate 1114, the base plate 1115 and the lateral plates 1111. The rear plate 1117 is connected between the lateral plates 1111.

On the other hand, as shown in FIG. 2, each of the first terminals 112 includes a first contacting portion 1121, a first connecting portion 1122 and an elastic sleeve 1123. The first contacting portion 1121 has a via hole HP. The elastic sleeve 1123 is located in the via hole HP. The first connecting portion 1122 is connected with the first contacting portion 1121. The first connecting portion 1122 of at least one of the first terminals 112 passes through the rear plate 1117 and is at least partially exposed out of the first insulating housing 111. The first isolating plate 1112 and the second isolating plate 1113 are at least partially located between the first contacting portions 1121 of the first terminals 112, and the via holes HP of the first contacting portions 1121 respectively align with the first opening OP1 and the second opening OP2.

Moreover, as shown in FIGS. 3-4, the snapping element 113 includes a first main body 1131 and a hooking portion 1132. The first main body 1131 has a first surface S1, a second surface S2 and a third surface S3. The first surface S1 and the second surface S2 are opposite to each other. The third surface S3 is connected between the first surface S1 and the second surface S2. The first surface S1 has an inner edge 1131e. The inner edge 1131e surrounds to define a recessed space R. The third surface S3 further has a recessed space C. The recessed space C is substantially formed from a recession from the third surface S3. The hooking portion 1132 is disposed on a portion of the second surface S2. The elastic element 114 is connected along the first direction D1 between the third surface S3 of the first main body 1131 and one of the two lateral plates 1111. For example, the elastic element 114 is at least partially accommodated in the recessed space C of the third surface S3, for being at least partially restricted by the first main body 1131. Moreover, the elastic element 114 is connected along the first direction D1 between the first main body 1131 and one of the two lateral plates 1111.

Furthermore, as shown in FIGS. 3-4, the first connector 110 further includes an elastic element 114 and a moving element 115. The moving element 115 includes a second main body 1151, a protruding portion 1152, two limiting portions 1153 and a handle 1154. The second main body 1151 is at least partially located in the activity space SM of the first insulating housing 111, and configured to move along the second direction D2. The protruding portion 1152 is connected with the second main body 1151. The protruding portion 1152 has an abutting surface SA. The abutting surface SA is at least partially inclined relative to the first direction D1. The abutting surface SA is configured to abut against the inner edge 1131e of the snapping element 113. The two limiting portions 1153 are disposed on two opposite sides of the second main body 1151. The two limiting portions 1153 are configured to snap with the limiting holes HR of the two lateral plates 1111.

To be specific, as shown in FIGS. 3-4, the second main body 1151 includes a structural portion 1151a, two pivotal portions 1151b and two extending portions 1151c. The protruding portion 1152 is connected with the structural portion 1151a. The two extending portions 1151c are respectively connected between the structural portion 1151a and a corresponding one of the two pivotal portions 1151b. The two limiting portions 1153 are disposed at two opposite sides of the structural portion 1151a. The handle 1154 is pivotally connected with the two pivotal portions 1151b and is able to rotate relative to the two pivotal portions 1151b. Correspondingly, as shown in FIGS. 2-3, the top plate 1114 has two avoidance portions 1114r. The two avoidance portions 1114r are respectively recessed from two opposite edges of the top plate 1114. The two extending portions 1151c respectively penetrate through the two avoidance portions 1114r.

Moreover, as shown in FIG. 2, the first isolating plate 1112 has a first height V1 relative to the base plate 1115. The second isolating plate 1113 has a second height V2 relative to the base plate 1115. In this embodiment, the first height V1 is larger than the second height V2. The first connecting portion 1122 of at least one of the first terminals 112 sequentially passes the first isolating plate 1112, the second isolating plate 1113 and the first contacting portion 1121 of at least another one of the first terminals 112, and is spaced apart from this first contacting portion 1121. According to the actual situation, the first connecting portion 1122 passing the first isolating plate 1112 and the second isolating plate 1113 and this first contacting portion 1121 can be disposed with an insulating layer (not shown) therebetween. The rear plate 1117 is located between these first connecting portions 1122. The first connecting portions 1122 are at least partially exposed out of the first insulating housing 111.

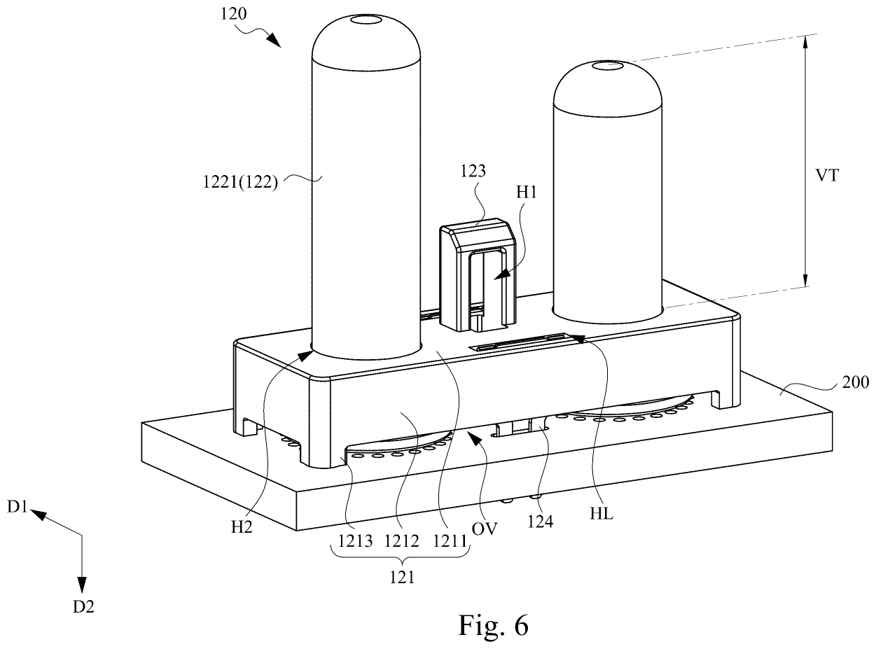

Please refer to FIG. 6. FIG. 6 is an enlarged schematic view of the second connector 120 of FIG. 1. In this embodiment, as shown in FIG. 6, the second connector 120 includes a second insulating housing 121, a plurality of second terminals 122 and a snapping portion 123. The second terminals 122 are connected with the second insulating housing 121. The second terminals 122 are configured to be connected with the first terminals 112 along the second direction D2. For example, each of the second contacting portions 1221 of the second terminals 122 has a terminal height VT. The terminal heights VT are different from each other. The snapping portion 123 is connected with the second insulating housing 121 and has a first through hole H1. The snapping portion 123 is configured to at least partially penetrate through the third opening OP3 to enter into the first insulating housing 111.

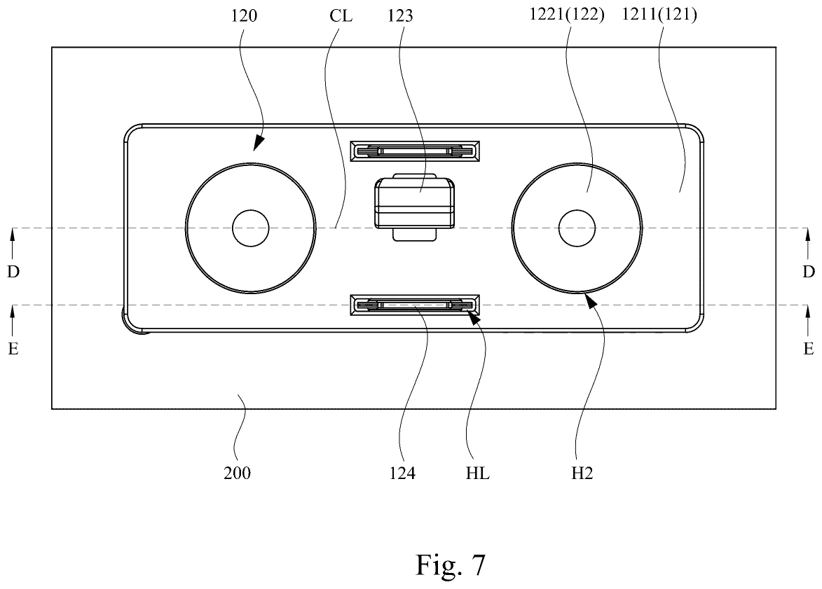

Please refer to FIG. 7. FIG. 7 is a top view of the second connector 120 of FIG. 6. In this embodiment, as shown in FIG. 7, the second terminals 122 are arranged along a contacting line CL. The snapping portion 123 is located between the second terminals 122 and offset from the contacting line CL. Correspondingly, as mentioned above, the third opening OP3 of the base plate 1115 is close to one of the two lateral plates 1111. In this way, when the first connector 110 is connected to the second connector 120 along the second direction D2, the relative position of the snapping portion 123 and the third opening OP3 can provide an effect of fool-proofing. Moreover, since the snapping portion 123 is located between the second terminals 122, while the corresponding snapping element 113 and the moving element 115 are both located between the first isolating plate 1112 and the second isolating plate 1113, the overall space occupied by the connector assembly 100 can be effectively reduced.

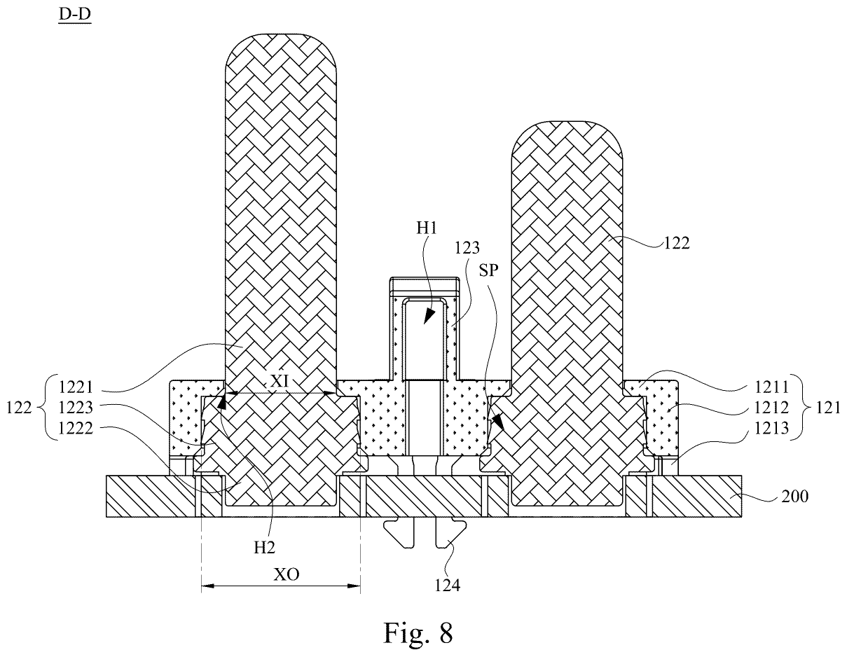

Please refer to FIGS. 6-8. FIG. 8 is a sectional view along the sectional line D-D of FIG. 7. In this embodiment, as shown in FIGS. 6-8, the second insulating housing 121 includes a plate portion 1211, a wall portion 1212 and a plurality of supporting portions 1213. The plate portion 1211 has a plurality of second through holes H2. The second through holes H2 respectively have an inner diameter XI. The wall portion 1212 is connected with the plate portion 1211. The wall portion 1212 surrounds to define an accommodation space SP. The wall portion 1212 is connected between the plate portion 1211 and the supporting portions 1213. The supporting portions 1213 are configured to abut against a board 200. For example, the board 200 is a printed circuit board. The supporting portions 1213 can make the plate portion 1211 and the board 200 be spaced apart from each other to form some vents OV, facilitating the effect of heat dissipation. Each of the second terminals 122 includes a second contacting portion 1221, a second connecting portion 1222 and a fixing portion 1223. Each of the second contacting portions 1221 penetrates through a corresponding one of the second through holes H2. The second connecting portion 1222 is configured to be electrically connected with the board 200. The fixing portion 1223 is connected between the second contacting portion 1221 and the second connecting portion 1222. The fixing portion 1223 is located in the accommodation space SP. The fixing portion 1223 has an outer diameter XO. The outer diameter XO of the fixing portion 1223 is larger than the inner diameter XI of the second through hole H2. Thus, the second terminals 122 are restricted in position by the second insulating housing 121.

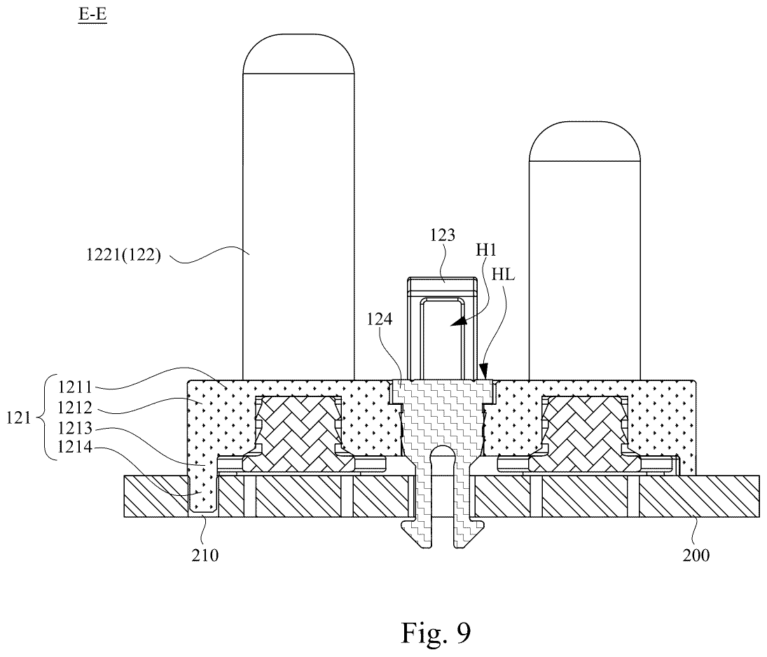

Please refer to FIGS. 6-7 and 9. FIG. 9 is a sectional view along the sectional line E-E of FIG. 7. In this embodiment, as shown in FIGS. 6-7 and 9, the plate portion 1211 of the second insulating housing 121 has at least one locking hole HL. Correspondingly, the second connector 120 further includes at least one locking piece 124. The locking piece 124 is configured to at least partially penetrate through and snap with the locking hole HL to lock at the board 200.

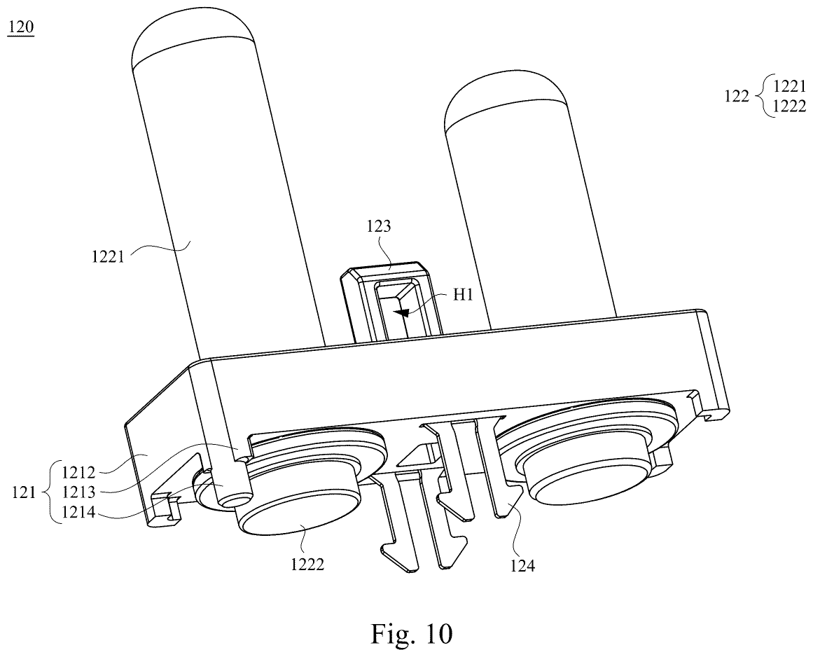

Please refer to FIGS. 9-10. FIG. 10 is a schematic bottom view of the second connector 120 of FIG. 6. In this embodiment, as shown in FIGS. 9-10, the second insulating housing 121 includes at least one first positioning portion 1214. The first positioning portion 1214 is disposed on one of the supporting portions 1213. The first positioning portion 1214 is configured to be connected with a second positioning portion 210 of the board 200. For example, the first positioning portion 1214 has a columnar shape, while the second positioning portion 210 is a hole with proper dimensions, such that the first positioning portion 1214 is suitable to be inserted into the second positioning portion 210.

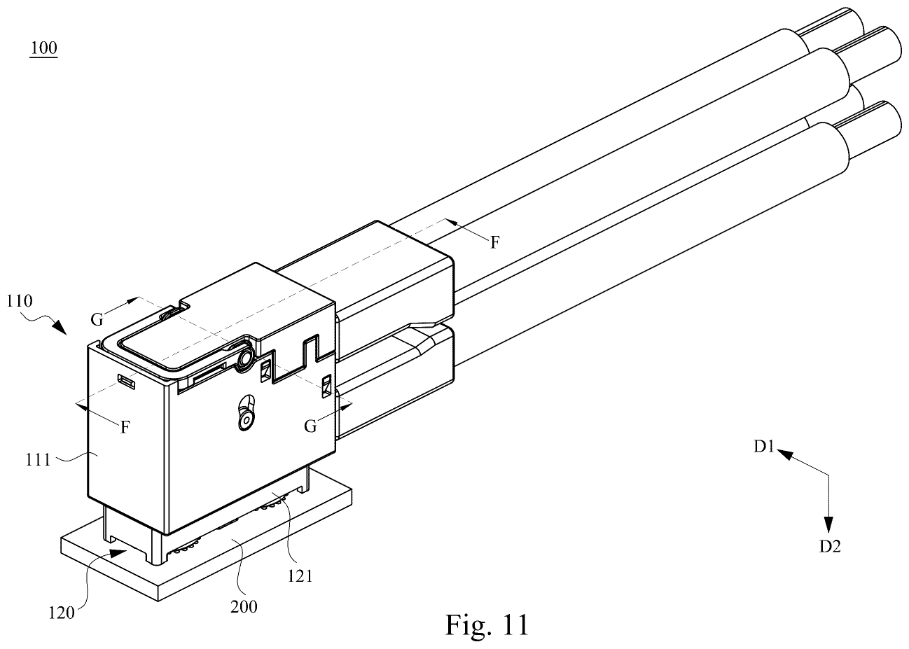

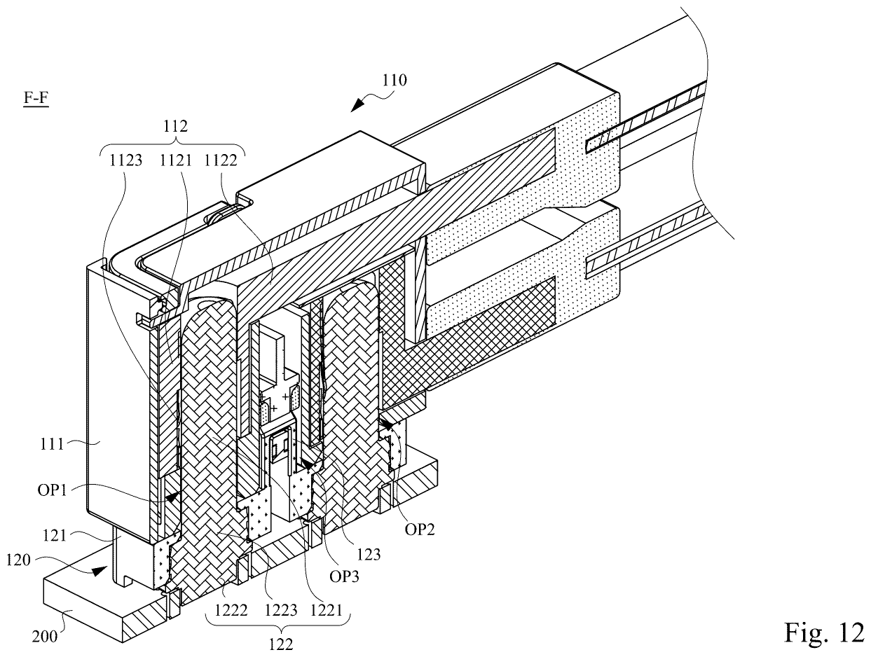

Please refer to FIGS. 11-12. FIG. 11 is a schematic view of the connector assembly 100 of FIG. 1, in which the first connector 110 and the second connector 120 are connected to each other. FIG. 12 is a sectional view along the sectional line F-F of FIG. 11. In this embodiment, as shown in FIGS. 11-12, when the first connector 110 and the second connector 120 are connected with each other, the first insulating housing 111 of the first connector 110 at least partially abuts against the second insulating housing 121 of the second connector 120, while the second contacting portions 1221 of the second terminals 122 of the second connector 120 respectively penetrate through the first opening OP1 and the second opening OP2 of the first connector 110 to connect with the elastic sleeves 1123 of the first connector 110, such that the electrical connection between the first connector 110 and the second connector 120 is achieved. The snapping portion 123 of the second connector 120 also penetrates through the third opening OP3 of the first connector 110 to enter into the first insulating housing 111.

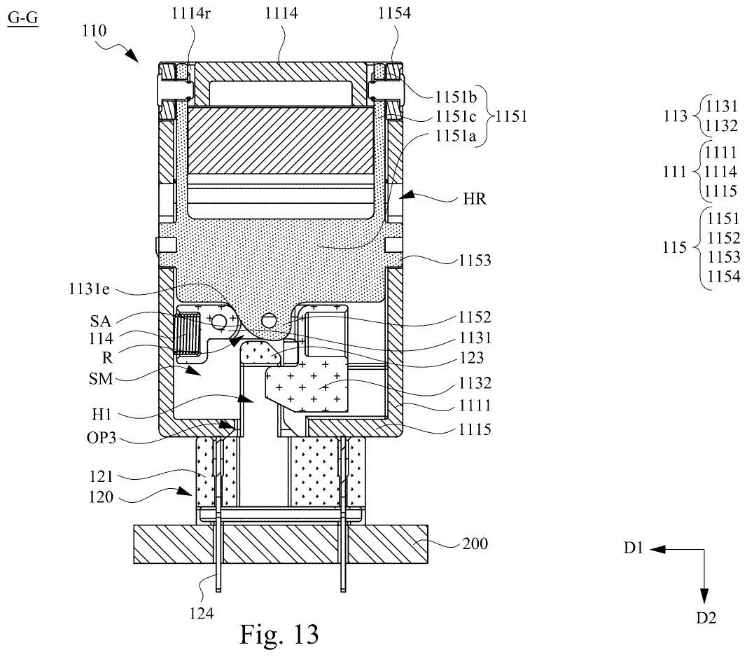

Please refer to FIG. 13. FIG. 13 is a sectional view along the sectional line G-G of FIG. 11. After the first insulating housing 111 of the first connector 110 at least partially abuts against the second insulating housing 121 of the second connector 120 as mentioned above, i.e., the second contacting portions 1221 of the second terminals 122 of the second connector 120 are already connected with the elastic sleeves 1123 of the first terminals 112, while the snapping portion 123 of the second connector 120 already enters into the first insulating housing 111, as shown in FIG. 13, a user can move the moving element 115 of the first connector 110 towards the second connector 120 along the second direction D2, such that the abutting surface SA of the moving element 115 abuts against the inner edge 1131e of the snapping element 113. This pushes the snapping element 113 to move along the first direction D1 to compress the elastic element 114, until the protruding portion 1152 of the moving element 115 is at least partially accommodated in the recessed space R of the snapping element 113, while the hooking portion 1132 of the snapping element 113 at least partially penetrates through the first through hole H1 of the snapping portion 123. Under such a situation, the first connector 110 cannot be detached from the second connector 120 along the second direction D2, i.e., the connection between the first connector 110 and the second connector 120 becomes secured and reliable.

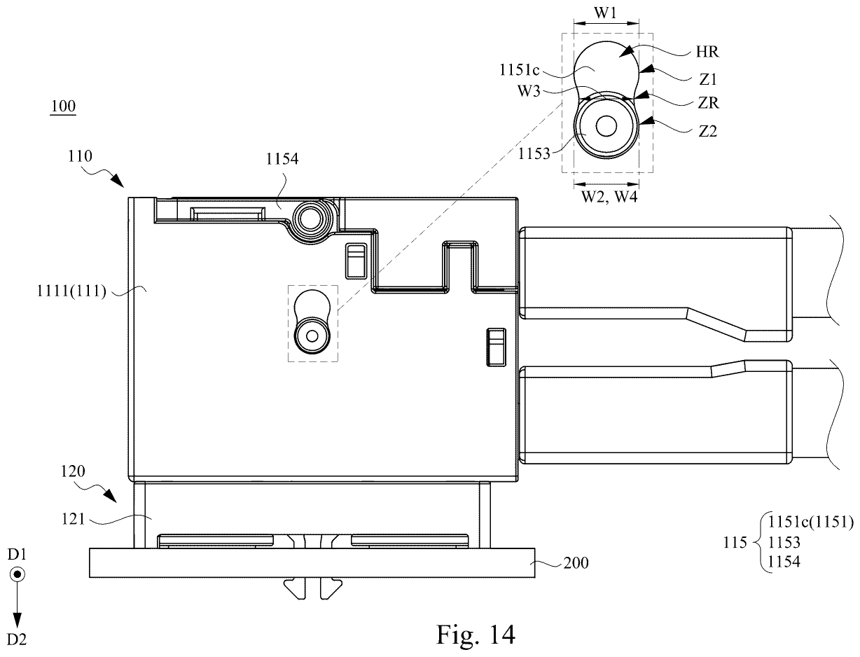

Please refer to FIG. 14. FIG. 14 is a partial side view of the connector assembly 100 of FIG. 11. In this embodiment, as shown in FIG. 14, the limiting hole HR of the lateral plate 1111 extends along the second direction D2 and is divided into a first zone Z1, a second zone Z2 and a limiting zone ZR communicated with each other. The limiting zone ZR is located between the first zone Z1 and the second zone Z2. The limiting hole HR has a first width W1 at the first zone Z1. The limiting hole HR has a second width W2 at the second zone Z2. The limiting hole HR has a third width W3 at the limiting zone ZR. The first width W1 is equal to the second width W2. The third width W3 is less than the first width W1 and the second width W2. When the moving element 115 is moved towards the second connector 120 along the second direction D2, such that the hooking portion 1132 of the snapping element 113 at least partially penetrates through the first through hole H1 of the snapping portion 123, the limiting portion 1153 of the moving element 115 also moves from the first zone Z1 to the second zone Z2. It is worth to note that, each of the limiting portions 1153 has a fourth width W4, and the fourth width W4 is equal to the first width W1 and the second width W2. In other words, in the moving process of the limiting portion 1153 from the first zone Z1 to the second zone Z2, the limiting portion 1153 passes the limiting zone ZR which is relatively narrower. Thus, the limiting portion 1153 (together with the moving element 115) can be switched between the first zone Z1 and the second zone Z2 only when a user exerts a force on the moving element 115. When the limiting portion 1153 is located at the second zone Z2, since the third width W3 of the limiting hole HR at the limiting zone ZR is less than the fourth width W4 of the limiting portion 1153, the limiting portion 1153 (together with the moving element 115) is restricted in the limiting zone ZR and does not move from the second zone Z2 to the first zone Z1 without any force exerted by a user. Thus, the snapping element 113 can keep compressing the elastic element 114, and the hooking portion 1132 of the snapping element 113 is at least partially maintained inside the first through hole H1 of the snapping portion 123. At this point, as shown in FIG. 11, the handle 1154 is rotated relative to the second main body 1151 and substantially parallel with the top plate 1114, so as to reduce the overall space occupied by the connector assembly 100.

When the first connector 110 is disconnected from the second connector 120, a user can rotate the handle 1154, such that the handle 1154 is perpendicular relative to the first insulating housing 111 (may refer to FIG. 1). At this point, the user can exert a force to the handle 1154, such that the handle 1154 (together with the moving element 115) is lifted up towards a direction away from the board 200 along the second direction D2, and the limiting portion 1153 of the moving element 115 is also moved from the second zone Z2 to the first zone Z1 through the limiting zone ZR. In this way, the protruding portion 1152 of the moving element 115 no longer abuts against the snapping element 113, and the compressed elastic element 114 releases its elastic potential energy to recover the snapping element 113, i.e., the hooking portion 1132 of the snapping element 113 no longer penetrates through the first through hole H1 of the snapping portion 123. At this point, the user can keep exerting a force to the handle 1154, such that the first connector 110 is disconnected from the second connector 120 along the second direction D2.

In other words, in the process of disconnecting the first connector 110 from the second connector 120, no additional tools are required, which brings convenience to the user.

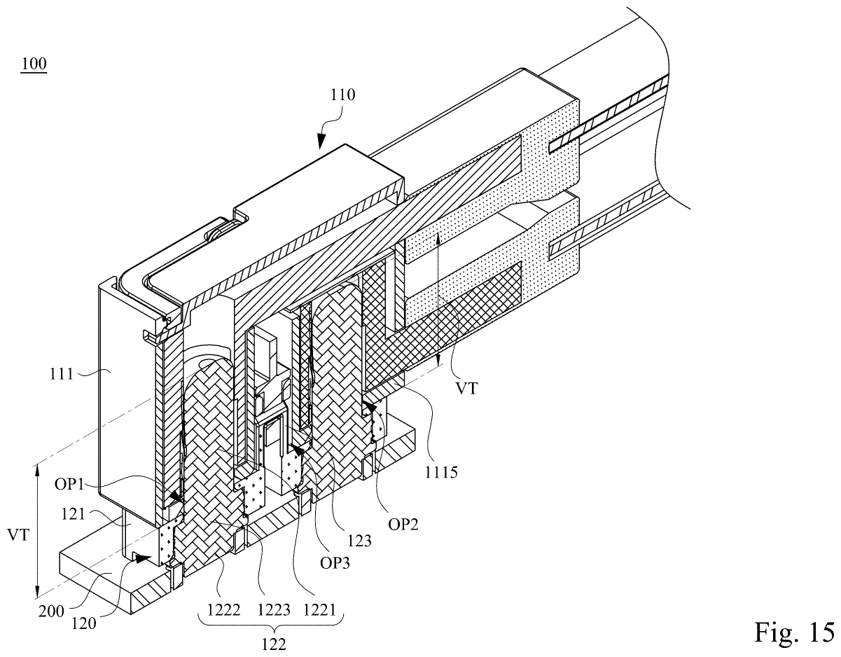

Please refer to FIG. 15. FIG. 15 is a partial section view of a connector assembly 100 according to another embodiment of the present disclosure. In this embodiment, as shown in FIG. 15, the terminal heights VT of the second contacting portions 1221 of the second terminals 122 can be equal to each other according to the actual situation, and a thickness of the base plate 1115 of the first insulating housing 111 can be correspondingly adjusted.

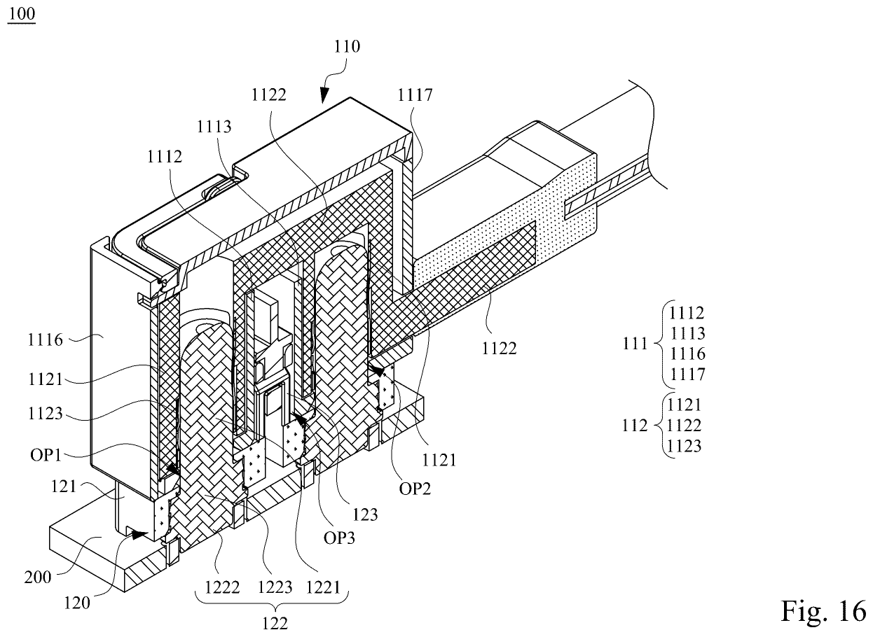

Please refer to FIG. 16. FIG. 16 is a partial section view of a connector assembly 100 according to a further embodiment of the present disclosure. In this embodiment, as shown in FIG. 16, the first connecting portion 1122 of at least one of the first terminals 112 is located between the front plate 1116 and the rear plate 1117, and sequentially passes the first isolating plate 1112 and the second isolating plate 1113 to connect with the first contacting portion 1121 of at least another one of the first terminals 112, such that the first terminals 112 form an integrally formed structure. In other words, in this embodiment, the first terminals 112 are connected with each other, allowing a higher current to flow through.

In conclusion, the aforementioned embodiments of the present disclosure have at least the following advantages:
(1) Since the hooking portion of the snapping element at least partially penetrates through the first through hole of the snapping portion, the connection between the first connector and the second connector becomes secured and reliable.
(2) In the process of disconnecting the first connector from the second connector, no additional tools are required, which brings convenience to the user.
(3) Since the snapping portion is located between the second terminals, while the corresponding snapping element and the moving element are both located between the first isolating plate and the second isolating plate, the overall space occupied by the connector assembly can be effectively reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connector assembly, comprising:
a first connector comprising:
a first insulating housing;
a plurality of first terminals connected with the first insulating housing; and
a snapping element elastically connected with the first insulating housing along a first direction; and
a second connector comprising:
a second insulating housing configured to at least partially abut against the first insulating housing;
a plurality of second terminals connected with the second insulating housing and configured to be connected with the first terminals along a second direction intersecting with the first direction; and
a snapping portion connected with the second insulating housing and configured to be at least partially inserted into the first insulating housing, the snapping element being configured to move along the first direction relative to the first insulating housing to snap with the snapping portion.

2. The connector assembly of claim 1, wherein the snapping portion has a first through hole, the snapping element comprises:
a first main body having a first surface, a second surface and a third surface, the first surface and the second surface are opposite to each other, the third surface is connected between the first surface and the second surface, the first surface has an inner edge surrounding to define a recessed space; and
a hooking portion disposed on the second surface and configured to at least partially penetrate through the first through hole,
the first connecter further comprises:
an elastic element connected between the third surface and the first insulating housing along the first direction; and
a moving element comprising:
a second main body at least partially located inside the first insulating housing and configured to move along the second direction; and
a protruding portion connected with the second main body and having an abutting surface, the abutting surface is at least partially inclined relative to the first direction and configured to abut against the inner edge in order to push the snapping element to move along the first direction to compress the elastic element, such that the protruding portion is at least partially accommodated in the recessed space.

3. The connector assembly of claim 2, wherein the first insulating housing comprises two lateral plates opposite to each other, the lateral plates respectively have a limiting hole extending along the second direction, the limiting hole is divided into a first zone, a second zone and a limiting zone communicated with each other, the limiting zone is located between the first zone and the second zone, the limiting hole has a first width at the first zone, the limiting hole has a second width at the second zone, the limiting hole has a third width at the limiting zone, the first width is equal to the second width, the third width is less than the first width and the second width, the moving element further comprises:
two limiting portions disposed on two opposite sides of the second main body and configured to snap with a corresponding one of the limiting holes, each of the limiting portions has a fourth width equal to the first width and the second width.

4. The connector assembly of claim 3, wherein the first insulating housing further comprises:
a first isolating plate connected between the lateral plates; and
a second isolating plate connected between the lateral plates, the second isolating plate and the first isolating plate define an activity space therebetween, the moving element is at least partially located in the activity space, the limiting holes are located between the first isolating plate and the second isolating plate, the first isolating plate and the second isolating plate are at least partially located between the first terminals.

5. The connector assembly of claim 4, wherein each of the first terminals comprises a first contacting portion, a first connecting portion and an elastic sleeve, the first contacting portion has a via hole, the elastic sleeve is located in the via hole, the first connecting portion is connected with the first contacting portion, the first insulating housing comprises:
a top plate;
a base plate, the lateral plates are connected between the top plate and the base plate, the base plate has a first opening, a second opening and a third opening, the first isolating plate and the second isolating plate are disposed between the base plate and the top plate and located between the first opening and the second opening, the via holes respectively align with the first opening and the second opening, the third opening is located between the first isolating plate and the second isolating plate, the third opening is configured to be penetrated through by the snapping portion;
a front plate connected with the top plate, the base plate and the lateral plates; and
a rear plate connected between the lateral plates, at least one of the first connecting portions passes through the rear plate and is at least partially exposed out of the first insulating housing.

6. The connector assembly of claim 5, wherein the first isolating plate has a first height relative to the base plate, the second isolating plate has a second height relative to the base plate, the first height is larger than the second height, the first connecting portion of at least one of the first terminals sequentially passes the first isolating plate, the second isolating plate and the first contacting portion of at least another one of the first terminals, the rear plate is located between the first connecting portions, the first connecting portions are at least partially exposed out of the first insulating housing.

7. The connector assembly of claim 5, wherein the first isolating plate has a first height relative to the base plate, the second isolating plate has a second height relative to the base plate, the first height is larger than the second height, the first connecting portion of at least one of the first terminals is located between the front plate and the rear plate and sequentially passes the first isolating plate and the second isolating plate to connect with the first contacting portion of at least another one of the first terminals, such that the first terminals form an integrally formed structure.

8. The connector assembly of claim 5, wherein the top plate has two avoidance portions respectively recessed from two opposite edges of the top plate, the second main body comprises:
a structural portion, the protruding portion is connected with the structural portion;
two pivotal portions; and
two extending portions respectively connected between the structural portion and a corresponding one of the pivotal portions, the limiting portions are disposed at two opposite sides of the structural portion, the extending portions respectively penetrate through the avoidance portions,
the moving element further comprises:
a handle pivotally connected with the pivotal portions.

9. The connector assembly of claim 5, wherein the second insulating housing comprises:
a plate portion has a plurality of second through holes respectively having an inner diameter;
a wall portion connected with the plate portion and surrounding to define an accommodation space; and
a plurality of supporting portions, the wall portion is connected between the plate portion and the supporting portions, the supporting portions are configured to abut against a board,
each of the second terminals comprises:
a second contacting portion penetrating through a corresponding one of the second through holes and configured to penetrate through a corresponding one of the first opening and the second opening to connect with a corresponding one of the elastic sleeves;
a second connecting portion configured to be electrically connected with the board; and
a fixing portion connected between the second contacting portion and the second connecting portion and located in the accommodation space, the fixing portion has an outer diameter larger than the inner diameter.

10. The connector assembly of claim 9, wherein the second insulating housing comprises:
at least one first positioning portion disposed on one of the supporting portions and configured to be connected with a second positioning portion of the board.

11. The connector assembly of claim 9, wherein the plate portion has at least one locking hole, the second connector further comprises:
at least one locking piece configured to at least partially penetrate through and snap with the locking hole to lock at the board.

12. The connector assembly of claim 9, wherein each of the second contacting portions has a terminal height, the terminal heights are different from each other.

13. The connector assembly of claim 9, wherein each of the second contacting portions has a terminal height, the terminal heights are equal to each other.

14. The connector assembly of claim 5, wherein the second terminals are arranged along a contacting line, the snapping portion is located between the second terminals and offset from the contacting line, the third opening is close to one of the lateral plates.

15. A connector assembly, comprising:
a cable end connector comprising:
a first insulating housing;
a plurality of first terminals connected with the first insulating housing;
a plurality of cables connected with the first terminals;
a snapping element disposed inside the first insulating housing and being elastically movable relative to the first insulating housing along a first direction; and
a moving element movably connected with the first insulating housing along a second direction intersecting with the first direction, the moving element being configured to push the snapping element to at least partially move relative to the first insulating housing along the first direction; and
a board end connector comprising:
a second insulating housing configured to at least partially abut against the first insulating housing;
a plurality of second terminals connected with the second insulating housing and configured to be connected with the first terminals along the second direction, the second terminals being electrically connected with a printed circuit board; and
a snapping portion connected with the second insulating housing and configured to be at least partially inserted into the first insulating housing, the snapping element being configured to move along the first direction relative to the first insulating housing to snap with the snapping portion.

16. The connector assembly of claim 15, wherein the moving element is configured to move relative to the first insulating housing to switch between a first position to push the snapping element and a second position to move away from the snapping element.
